(19) United States
(12) Patent Application Publication
(10) Pub. No.: US 2021/0304575 A1
(43) Pub. Date: Sep. 30, 2021

(54) MONITORING INFORMATION RECORDING APPARATUS, MONITORING INFORMATION RECORDING SYSTEM, CONTROL METHOD FOR MONITORING INFORMATION RECORDING APPARATUS, AND RECORDING MEDIUM

(71) Applicant: SHARP KABUSHIKI KAISHA, Sakai City, Osaka (JP)

(72) Inventors: KEISUKE OMORI, Sakai City, Osaka (JP); KEI TOKUI, Sakai City, Osaka (JP)

(21) Appl. No.: 17/266,292

(22) PCT Filed: Jul. 17, 2019
(86) PCT No.: PCT/JP2019/028143

§ 371 Date: Feb. 5, 2021

(30) Foreign Application Priority Data
Aug. 10, 2018 (JP) 2018-151485

(51) Int. Cl. G08B 13/196

(52) U.S. Cl. CPC G08B 13/19667; G08B 13/19673; G08B 13/19652; G08B 13/19669

(57) ABSTRACT

A monitoring information recording apparatus according to one aspect, includes a recording processing unit configured to record, in a case that monitoring information including-at least one of a captured image of a monitoring target and a measurement value calculated based on the captured image meets a predetermined criterion, the monitoring information in a first mode. The recording processing unit, records, in a case that the monitoring information has not been recorded in the first mode for a predetermined period of time or longer, the monitoring information in the first mode regardless of whether the above criterion is met or not.

### TECHNICAL FIELD

The present invention relates to a monitoring information recording apparatus, a monitoring information recording system, a control method for the monitoring information recording apparatus, a monitoring information recording program, and a recording medium.

The present application claims priority to JP 2018-151485 filed in Japan on Aug. 10, 2018, of which contents are incorporated herein by reference.

### BACKGROUND ART

In recent years, monitoring cameras for a purpose such as crime prevention or disaster prediction have been developed. Since a monitoring camera always captures a monitoring target, the data volume of captured images and measurement values based on the captured images become considerably large, and it is impractical to record all of the captured images and the measurement values. Thus, there is a demand for a technique that is possible to efficiently record monitoring information to reduce the data volume of the monitoring information such as captured images and measurement values to be recorded.

As a technique such as that described above, PTL 1 describes a technique in which a storage frame rate is increased when abnormality is detected in a monitoring target region, and the storage frame rate is lowered as time passes from the point in time of the abnormality detection, thereby suppressing the data volume of the captured images to be recorded. PTL 2 describes a technique in which the data volume of captured images to be recorded is suppressed by calculating evaluation values indicating importance of video data and compressing the video data based on the evaluation values. PTL 3 describes a technique in which a difference in image information between two sets of captured images adjacent in chronological order is detected, and it is determined whether one of the sets of captured images is deleted or both of them are recorded based on the magnitude of the difference.

### CITATION LIST

### Patent Literature

PTL 1: JP 2007-300462 A

PTL 2: JP 2012-39284 A

PTL 3: JP 2016-58867 A

### SUMMARY OF INVENTION

### Technical Problem

However, in the techniques described in PTL 1 to PTL 3, there is a possibility that even important monitoring information is not recorded.

A main object of one aspect of the present invention is to provide a monitoring information recording apparatus able to suppress the data volume of monitoring information to be recorded while suitably recording important monitoring information, and to provide related techniques of the monitoring information recording apparatus.

### Solution to Problem

A monitoring information recording apparatus according to one aspect of the present invention includes a recording processing unit configured to record, in a case where monitoring information including at least one of a captured image of a monitoring target and a measurement value calculated based on the captured image meets a predetermined criterion, the monitoring information in a first mode. The recording processing unit records, in a case where the monitoring information has not been recorded in the first mode for a predetermined period of time or longer, the monitoring information in the first mode regardless of whether the criterion is met or not.

A control method for a monitoring information recording apparatus according to one aspect of the present invention is a control method for the monitoring information recording apparatus, the control method including a step of recording, in a case where monitoring information including at least one of a captured image of a monitoring target and a measurement value calculated based on the captured image meets a predetermined criterion, the monitoring information in a first mode by the monitoring information recording apparatus. In the above recording step, in a case where the monitoring information has not been recorded in the first mode for a predetermined period of time or longer, the monitoring information is recorded in the first mode by the monitoring information recording apparatus regardless of whether the criterion is met or not.

### Advantage Effects of Invention

According to one aspect of the present invention, it is possible to suppress the data volume of monitoring information to be recorded while suitably recording important monitoring information.

### BRIEF DESCRIPTION OF DRAWINGS

FIG. 1 is a block diagram illustrating a configuration of a main section of a storage system according to a first embodiment.

FIG. 2 is a graph showing an example of results of measurement values by a measurement unit in a storage device according to the first embodiment.

FIG. 3 is a diagram in which monitoring information is arranged in chronological order.

FIG. 4 is a flowchart illustrating an example of a flow of a control process of the storage device according to the first embodiment.

FIG. 5 is a diagram illustrating captured images and a graph of a time-passage change in a measurement value.

FIG. 6 is a diagram illustrating an example of captured images.

FIG. 7 is a graph showing an example of time-passage changes in a measurement value and in temperature.

FIG. 8 is a graph showing an example of time-passage changes in a measurement value and in temperature.

FIG. 9 is a graph showing an example of a time-passage change in a measurement value.

### DESCRIPTION OF EMBODIMENTS

### First Embodiment

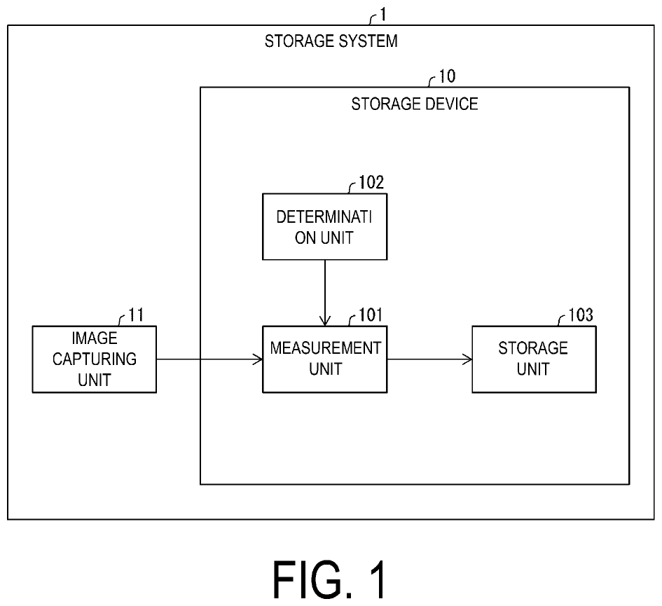

Hereinafter, a storage system (monitoring information recording system) 1, a storage device (monitoring information recording apparatus) 10, and a control method for the storage device (monitoring information recording apparatus) 10 according to a first embodiment will be described in detail by using FIGS. 1 to 4.

Storage System 1

FIG. 1 is a block diagram illustrating a configuration of a main section of the storage system 1 according to the first embodiment. As illustrated in FIG. 1, the storage system 1 includes the storage device 10 and an image capturing unit 11.

Image Capturing Unit 11

The image capturing unit 11 is a unit configured to image-capture an imaging target subject as a monitoring target. A captured image of the imaging target subject (monitoring target) captured by the image capturing unit 11 is inputted as an input image to the storage device 10. Specific examples of the image capturing unit 11 include cameras for a variety of applications, such as a security camera installed in a condominium, a building or the like, a camera for monitoring the water level of a river, and a measuring camera used for maintenance of mechanical equipment or the like. Hereinafter, a case in which the image capturing unit 11 is a measuring camera used for maintenance will be described. In particular, a case will be described in which the image capturing unit 11 measures, from the captured images, a minute change in a displacement amount of the installation position of a monitoring target or an amount of wear of the monitoring target.

There is a case in which the image capturing unit 11 captures the monitoring target as a video, and there is a case in which the image capturing unit 11 captures the monitoring target as a still image. In the case of capturing the target as a video, the number of images to be captured per unit time (frame rate) is set. In the case of capturing the target as a still image, the number of images to be captured per unit time is also set as in the video.

The number of images to be captured per unit time may be set to an appropriate value in accordance with the monitoring target. For example, the image capturing interval may be set to be long such as one image per minute or one image per hour. The value of the number of images to be captured per unit time may be set in advance. The number of images to be captured per unit time may be set based on a measurement value calculated by a measurement unit 101, a determination result by a determination unit 102, or a recording capacity or a residual quantity of the recording capacity of a storage unit (recording processing unit) 103, or may be set manually by a user.

Storage Device 10

The storage device 10 includes the measurement unit 101, the determination unit 102, and the storage unit 103. The determination unit 102 and the storage unit 103 constitute the recording processing unit.

Measurement Unit 101

The measurement unit 101 calculates a measurement value based on a captured image of a monitoring target. The method for calculating a measurement value based on a captured image is not particularly limited, and for example, the measurement unit 101 may calculate a measurement value, such as a displacement amount from a standard value, by comparing a captured image taken by the image capturing unit 11 constituted of a single camera with a standard template image that has been input beforehand. In a case where an imaging target subject of a known size is taken in a captured image along with a monitoring target, the measurement unit 101 can calculate a measurement value, such as a length of the monitoring target, by comparing the size of the imaging target subject with a size of the monitoring target in the captured image.

Further, the measurement unit 101 may calculate measurement values, such as a length, an area, and an angle of an imaging target subject, based on three-dimensional information obtained from a parallax between viewpoint images with respect to a captured image (two-viewpoint image) taken by the image capturing unit 11 constituted of a stereo camera. The three-dimensional information may be acquired along with a distance from the image capturing unit 11 to the imaging target subject, based on the parallax between the viewpoint images and the principle of triangulation.

In a case where information in a depth direction measured by a distance measurement sensor such as a time of flight (TOF) sensor is associated with a captured image taken by the image capturing unit 11 as a single camera, the measurement unit 101 may measure various measurement values of the monitoring target based on the information in the depth direction.

Determination Unit 102 and Storage Unit 103

The determination unit (recording processing unit) 102 determines whether to record, in a prioritized mode (first mode), monitoring information including at least one of a captured image taken by the image capturing unit 11 and a measurement value calculated by the measurement unit 101 based on the captured image. The storage unit (recording processing unit) 103 selectively records the monitoring information in a prioritized mode based on a determination result of the determination unit 102. The storage unit 103 records the information in, for example, a storage medium such as a hard disk, a flash memory, or an optical disk. The storage medium may be built in the storage device 10, may be detachable, or may be a server on a network.

The monitoring information is information including at least one of a captured image of a monitoring target captured by the image capturing unit 11 and a measurement value calculated by the measurement unit 101 based on the captured image.

To record in a prioritized mode means that the monitoring information is recorded in a mode in which a storage period is long or a recording capacity for each recording action or per unit time is large compared to a case of recording in a non-prioritized mode (second mode).

In one aspect, the storage unit 103 may maintain, for a long period of time, monitoring information determined by the determination unit 102 to be recorded in a prioritized mode, and may delete, in a short period of time, monitoring information determined by the determination unit 102 not to be recorded in a prioritized mode or may not record such monitoring information in the first place. The long period of time may be defined as a period of time longer than or equal to a predetermined first period of time, while the short period of time may be defined as a period of time shorter than or equal to a predetermined second period of time.

In one aspect, the storage unit 103 may include a long-period storage unit for long-period storage and a short-period storage unit for short-period storage, may store, in the long-period storage unit, monitoring information determined by the determination unit 102 to be recorded in a prioritized mode, and may store, in the short-period storage unit, monitoring information determined by the determination unit 102 not to be recorded in a prioritized mode. Assume that the information recorded in the short-period storage unit is deleted after the passage of a prescribed period of time or at an optional timing.

In one aspect, the storage unit 103 may record, in a low compression or non-compression state, monitoring information determined by the determination unit 102 to be recorded in a prioritized mode, or may record, in a high compression state, monitoring information determined by the determination unit 102 not to be recorded in a prioritized mode. In this case, the storage unit 103 may include a compression unit configured to compress data by using a known algorithm. The high compression may be defined as compression equal to or larger than a predetermined first compression ratio, while the low compression may be defined as compression equal to or smaller than a predetermined second compression ratio.

In one aspect, the determination unit 102 may determine a priority for each monitoring information, and the storage unit 103 may record the monitoring information compressed at a compression ratio in accordance with the priority. In such an aspect, for example, in a case where a mode in which recording with non-compression or low compression is performed is defined as a prioritized mode, the priority is considered to be information indicating whether the monitoring information is recorded in the prioritized mode.

In one aspect, the storage unit 103 may record, as is, the monitoring information determined by the determination unit 102 to be recorded in the prioritized mode, and may take out only a necessary portion from the monitoring information determined by the determination unit 102 not to be recorded in the prioritized mode (for example, by deleting a region that is not related to the measurement in the captured image) and record the taken-out portion.

In one aspect, as for monitoring information to be recorded in the storage unit 103, the determination unit 102 determines whether to record the monitoring information in a prioritized mode. The storage unit 103 records, in a prioritized mode, the monitoring information determined by the determination unit 102 to be recorded in the prioritized mode, and records, in a non-prioritized mode, the monitoring information determined by the determination unit 102 not to be recorded in the prioritized mode or does not record such monitoring information.

In another aspect, as for the monitoring information having already been recorded in the storage unit 103, the determination unit 102 determines whether to cause a recording mode of the monitoring information to be a prioritized mode. In a case where the determination unit 102 determines that the monitoring information having been recorded in the storage unit 103 should be recorded in a prioritized mode, the storage unit 103 causes the recording mode of the recording information to be the prioritized mode, and in a case where the determination unit 102 does not determine that the monitoring information should be recorded in a prioritized mode, the storage unit 103 causes the recording mode of the monitoring information to be a non-prioritized mode or deletes such monitoring information. For example, the determination unit 102 may be configured to determine whether to delete the monitoring information having already been recorded in the storage unit 103, and the storage unit 103 may be configured to delete the monitoring information determined by the determination unit 102 to be deleted (determined not to be recorded in the prioritized mode).

Details of Determination by Determination Unit 102

Next, details of the determination made by the determination unit 102 will be described. In one aspect, the determination unit 102 determines that the monitoring information is to be recorded in a prioritized mode in a case where a predetermined criterion is met, and in a case where the monitoring information has not been recorded in a prioritized mode for a predetermined period of time or longer, the determination unit 102 determines that the monitoring information is to be recorded in a prioritized mode regardless of whether the criterion is met or not.

The criterion used by the determination unit 102 is not particularly limited, and various criteria may be used. In one aspect, the criterion used by the determination unit 102 may be a criterion for determining whether the measurement value falls within a normal range or within an abnormal range, and the criterion is considered as being met when the measurement value falls within the abnormal range.

In another aspect, the criterion used by the determination unit 102 may be a criterion used in the following manner. In the case where the determination unit 102 compares the latest measurement value calculated by the measurement unit 101 with the past measurement value recorded in the storage unit 103, it is determined that the latest measurement value is in a normal state when a difference between the past measurement value and the latest measurement value falls within a predetermined range in a predetermined period of time, and it is determined that the latest measurement value is in an abnormal state when the above difference does not fall within the predetermined range; the criterion is considered as being met when the latest measurement value is in the abnormal state.

In yet another aspect, the criterion used by the determination unit 102 may be a criterion for determining, based on a time-passage change in the measurement value, whether the measurement value in the past or at the point in time is normal or abnormal, and the criterion is met when the measurement value is abnormal. In this case, for example, the determination unit 102 may perform pattern-matching on the time-passage change in the measurement value, and may refer to a parameter associated with the matching pattern to determine whether the measurement value in the past or at the point in time is normal or abnormal. The parameter may indicate, for example, whether the measurement value corresponding to each position of the associated pattern is normal or abnormal.

Next, an effect of the determination by the determination unit 102 will be described in which, in a case where the monitoring information has not been recorded in a prioritized mode for a predetermined period of time or longer, the monitoring information is determined to be recorded in a prioritized mode regardless of whether the criterion is met or not.

For example, it may be important to confirm that a monitoring target is in a normal state depending on the monitoring target and a measurement purpose, in such a case that a mechanical apparatus used in maintenance operation is a monitoring target and it is determined whether the mechanical apparatus is in a normal state.

However, any of the conventional techniques described in PTL 1 to PTL 3 is a technique configured to record a captured image in an abnormal state, and thus no consideration is given to the recording of a captured image in a normal state. As such, the conventional techniques neither instruct nor suggest how to suitably record a captured image in a normal state.

In contrast, even in a case where the measurement value has been indicating a normal state for a long period of time, and it should be determined not to record monitoring information in a prioritized mode based on a criterion for determining an abnormal state, the determination unit 102 determines to record the monitoring information in the storage unit 103 when the monitoring information has not been recorded in the prioritized mode for a predetermined period of time or longer.

With this, at a later time, by referring to the monitoring information recorded in the storage unit 103, it is possible to suitably confirm whether the monitoring information has reliably indicated a normal state. Thus, according to the present embodiment, important monitoring information can be suitably recorded.

The measurement value is generally smaller in data volume than the captured image. Therefore, only the measurement value may be recorded in the storage unit 103. On the other hand, in a case where the state of the monitoring target is minutely investigated at a later time, the captured image is preferably recorded in the storage unit 103.

The above-described “predetermined period of time” can be optionally set in accordance with the monitoring target. For example, in a case of a monitoring target that needs a periodic inspection once a day, the predetermined period of time may be set to 24 hours in order that an interval at which the monitoring information recorded in the storage unit 103 is inspected does not exceed one day or more. In a case of a monitoring target that needs a periodic inspection in the morning, in the afternoon, and at night, the predetermined period of time may be set to eight hours.

The above-described “predetermined period of time” may be variably set in accordance with the frequency of use of the monitoring target, or the like. For example, in a case of a monitoring target used in the daytime but not used in the night-time, the predetermined period of time for the daytime may be set to be shorter, while the predetermined period of time for the night-time may be set longer. The monitoring target is not particularly limited as long as the measurement value is calculated based on the captured image, and examples of the monitoring target in which the measurement value changes with the passage of time include a tire of an automobile.

In one aspect, in a case where the determination unit 102 determines whether the monitoring information having already been recorded in the storage unit 103 should be deleted, and the storage unit 103 is configured to delete the monitoring information determined by the determination unit 102 to be deleted (determined not to be recorded in the prioritized mode), the above “predetermined period of time” may also be referred to as the “longest deletion period of time” since it represents the longest period of time in which the recording information may be continuously deleted.

Operation Example of Storage Device 10

Next, several examples of operations of the storage device 10 will be described.

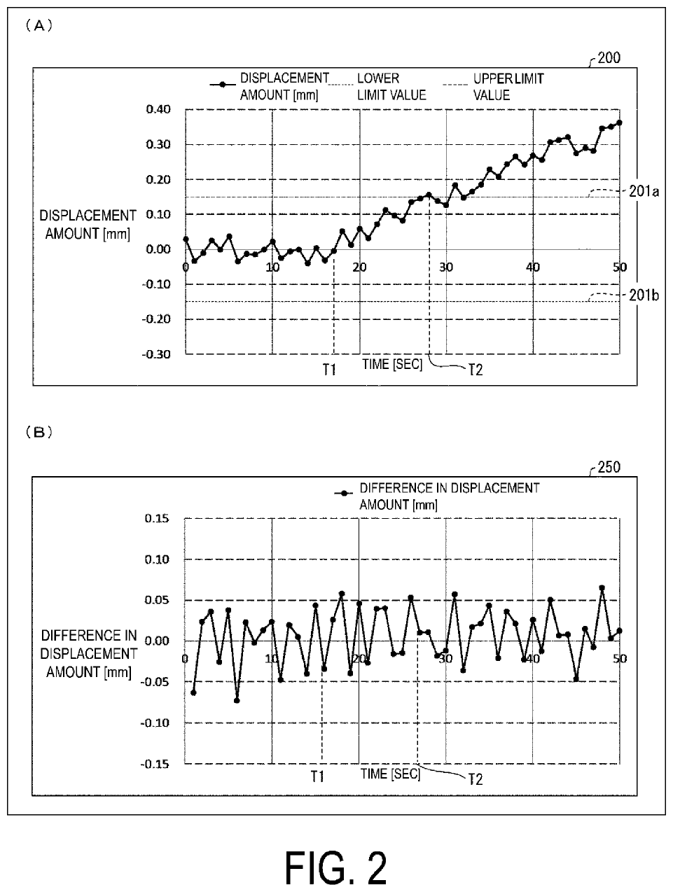

(A) of FIG. 2 shows a graph 200 depicting a time-passage change in displacement amount of a monitoring target in a captured image calculated by the measurement unit 101 based on the captured image. In the graph 200, an upper limit value 201a and a lower limit value 201b of the displacement amount determined to be normal are each indicated by a broken line. In the following, a region between the upper limit value 201a and the lower limit value 201b is referred to as a normal region.

As is apparent from (A) of FIG. 2, all of the displacement amounts take a value within the normal region before time T2, and it is not until the time T2 that the displacement amount takes a value outside of the normal region. At the time T2 and after that, almost all of the displacement amounts take a value outside of the normal region. Accordingly, in a case where a normal state or an abnormal state is determined based on only whether the displacement amount falls within the normal region, since it is not until the time T2 that the displacement amount is brought into the abnormal state, the time T2 is determined to be the time corresponding to the abnormal state.

On the other hand, as shown in (A) of FIG. 2, when focusing on the time-passage change in displacement amount in the graph 200, a tendency can be observed in which the displacement amount starts to shift toward the upper right from approximately time T1 earlier than the time T2. Thus, in reality, the abnormal state does not occur suddenly at the time T2, but an event that causes the abnormal state may have occurred approximately at the time T1.

In order to see whether an event that causes the abnormal state has occurred, the determination unit 102 may determine whether to record the monitoring information in the storage unit 103 based on a difference in the measurement value such as a displacement amount calculated by the measurement unit 101, and the storage unit 103 may record the monitoring information based on the determination result of the determination unit 102. An example in which the storage unit 103 selectively records displacement amounts based on a difference in displacement amount will be described below by using (B) of FIG. 2. (B) of FIG. 2 shows a graph 250 depicting difference data of the displacement amounts depicted in the graph 200. By selectively recording the displacement amounts based on the difference in displacement amount, when a large change in displacement amount occurs at a certain time, the displacement amount at that time can be confirmed. As a result, it is possible to suitably see whether an event that causes an abnormal state of the measurement value has occurred.

In a case where measurement values are recorded based on only a difference in the measurement values such as displacement amounts, the displacement amount (measurement value) in the abnormal state may not be seen from a difference between values in front and behind, as in the graph 250 shown in (B) of FIG. 2. In contrast, as shown in (A) of FIG. 2, the storage unit 103 records the monitoring information based on the time-passage change in the displacement amount, whereby the displacement amount (measurement value) in the abnormal state may be suitably recorded. From this, it is preferable that the determination unit 102 determine whether to record the captured images in the storage unit 103 based not only on the displacement amount at each point in time, but also on the time-passage change in the displacement amount, and that the storage unit 103 selectively record the captured images based on the determination result of the determination unit 102. For example, the determination unit 102 may cause the storage unit 103 to record a captured image corresponding to a displacement amount determined to be in the abnormal state from the graph depicting the time-passage change in the displacement amount, and may cause the storage unit 103 not to record a captured image corresponding to a displacement amount determined to be in the normal state. This makes it possible for the storage unit 103 to more efficiently suppress the data volume of the captured images to be recorded while more favorably recording important captured images. In this manner, by selectively recording the monitoring information based on the time-passage change in the displacement amount, it is possible to more preferably record important monitoring information, and prevent unnecessary monitoring information from being recorded. This makes it possible to more efficiently utilize the recording capacity of the storage unit 103.

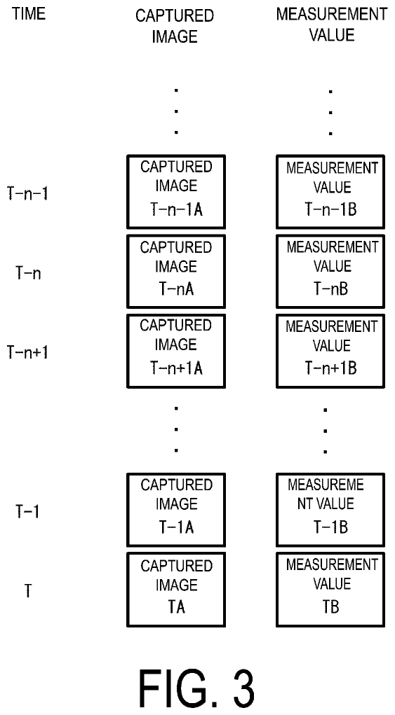

The storage unit 103 may selectively record the monitoring information as follows. A selective recording example 2 by the storage unit 103 will be described below by using FIG. 3. FIG. 3 is a diagram in which monitoring information is arranged in chronological order. More specifically, FIG. 3 is a diagram in which captured images T-n-1A to TA sequentially taken by the image capturing unit 11 and input into the storage device 10, and measurement values T-n-1B to TB respectively corresponding to the above captured images are arranged in chronological order from time T-n-1 to a second time T, respectively. Here, a case is described in which the storage unit 103 stores the captured image and the measurement value at each time for a short period of time, and the captured image determined, by the determination unit 102, not to be recorded in the storage unit 103 is deleted. As illustrated in FIG. 3, the current time is the second time T, and the captured image TA and the measurement value TB corresponding to the captured image TA at the second time T, and the captured images and measurement values at each time earlier than the second time T are stored in the storage unit 103 for a short period of time.

Hereinafter, a case in which the storage unit 103 selectively records the captured image T-nA at the first time T-n based on the measurement values from the first time T-n to the second time T will be described. For example, in the case where the measurement values from the first time T-n to the second time T fall within a predetermined range and are numeric values in the normal state, the determination unit 102 determines to delete at least one of the captured image T-nA and the measurement value T-nB at the first time T-n, and the storage unit 103 selectively records the captured image T-nA at the first time T-n based on the determination result of the determination unit 102. Hereinafter, a case will be described in which the determination unit 102 determines whether the captured image T-nA at the first time T-n is recorded in the storage unit 103 based on a determination condition (1) that the captured image T-nA at the first time T-n is deleted when the measurement values from the first time T-n to the second time T are in the normal state. For example, in a case where the first time T-n corresponds to the time T1 of the graph 200 shown in (A) of FIG. 2, and the second time T corresponds to the time T2 thereof, the time T2 represents a numeric value in the abnormal state. Therefore, the determination unit 102 determines that the captured image at the time T1 is a captured image to be recorded. As shown in (A) of FIG. 2, there is a tendency for the displacement amount to increase toward the upper right in the graph 200 from approximately the time T1, and it is implied that an even that causes the abnormal state may have occurred approximately at the time T1. In contrast, as described above, by the determination unit 102 making the determination based on the determination condition (1), the storage unit 103 can suitably record the captured image at the time at which the event that causes the abnormal state may have occurred because the captured image at the time T1 is recorded. In a case where a measuring state of the measurement values continues for a certain period of time, by deleting, rather than recording, the captured image at the first time T-n as discussed above, it is possible to suppress a situation in which the captured images are recorded more than necessary, and more suitably suppress the data volume of the captured images to be recorded. In this way, since the determination unit 102 determines, by the above-described determination condition (1), whether to record the monitoring information in the storage unit 103 based on the degree of the time-passage change in the measurement value, the storage unit 103 can record the monitoring information more suitably.

In a case where a difference in measurement value between adjacent captured images is equal to or less than a predetermined threshold value, the determination unit 102 may determine whether to record the captured image T-nA at the first time T-n based on a determination condition (2), in addition to the above determination condition (1), which determines not to record the adjacent captured images in the storage unit 103. For example, in a case where the measurement value rapidly changes from a measurement value near the lower limit value 201b of the measurement value in the normal state to a measurement value near the upper limit value 201a of the measurement value in the normal state, an event that causes the abnormal state may have occurred. However, in this case, since both the measurement value T-nB and the measurement value TB fall within a range determined to be normal, when the determination is made by the determination unit 102 based on the determination condition (1) described above, the captured image of the measurement value T-nB is a target not to be recorded. In contrast, by the determination unit 102 making the determination based on the determination condition (2) described above, the storage unit 103 can record the captured image when the measurement value rapidly changes. In a case where the measurement unit 101 calculates a minute displacement amount such as the amount of wear of the monitoring target, the number of captured images increases when the measurement frequency is set to be high in order to calculate a rapid change in the displacement amount that occurs suddenly, or the like. In contrast, by determining whether to record the captured image in the storage unit 103 based on the determination conditions (1) and (2) described above, and by the storage unit 103 selectively recording the captured image based on the determination result of the determination unit 102, it is possible to suppress the data volume of the monitoring information while suppressing a situation in which a sudden change in the measurement value of the monitoring target is not observed.

As described above, according to the present embodiment, by setting a criterion, and by the determination unit 102 determining whether to record the monitoring information in the storage unit 103, the data volume of the monitoring information may be suppressed. In a case where the monitoring information has not been recorded for a predetermined period of time or longer, by causing the storage unit 103 to record the monitoring information, important monitoring information may be suitably recorded in the storage unit 103. That is, it is possible to efficiently utilize the recording capacity of the storage unit 103, and record the important monitoring information such as a measurement value indicating that the monitoring target is in the normal state.

Control Process of Storage Device 10

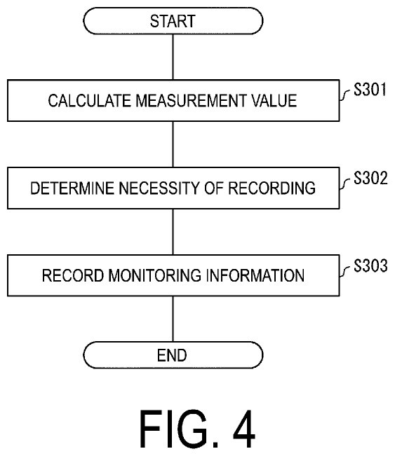

Next, a control process of the storage device 10 (a control method for the monitoring information recording apparatus) according to the first embodiment will be described by using FIG. 4. FIG. 4 is a flowchart illustrating an example of a flow of the control process of the storage device 10 according to the first embodiment. When the measurement unit 101 has acquired a captured image, the process is started.

In step S301, the measurement unit 101 extracts, based on a captured image of the monitoring target, the monitoring target from the captured image, and calculates a measurement value of the monitoring target (measurement step).

In step S302, the determination unit 102 determines, based on a predetermined criterion, whether to record the monitoring information, which is at least one of the captured image and the measurement value, in the storage unit 103. In a case where the monitoring information has not been recorded for a predetermined period of time or longer, the determination unit 102 determines to record the monitoring information in the storage unit 103 regardless of the determination result.

In step S303, the storage unit 103 selectively records the monitoring information based on the predetermined criterion, that is, based on the determination result of the determination unit 102. In the case where the monitoring information has not been recorded for the predetermined period of time or longer regardless of the determination result of the determination unit 102, the storage unit 103 records the monitoring information regardless of the determination result of the determination unit 102 and then terminates the process (recording processing step).

### Second Embodiment

In the storage device 10 of the storage system 1 according to the first embodiment, in the case where a measurement value does not fall within a predetermined range, the storage unit 103 selectively records monitoring information based on the criterion for considering the monitoring information corresponding to the above measurement value as a recording target. However, as in a storage system 2 (not illustrated) according to a second embodiment, in a case where the brightness of a captured image at the time of image capturing does not fall within a predetermined range, a storage unit 203 (not illustrated) in a storage device 20 (not illustrated) may selectively record monitoring information based on a criterion for considering the captured image corresponding to the above brightness as a recording target.

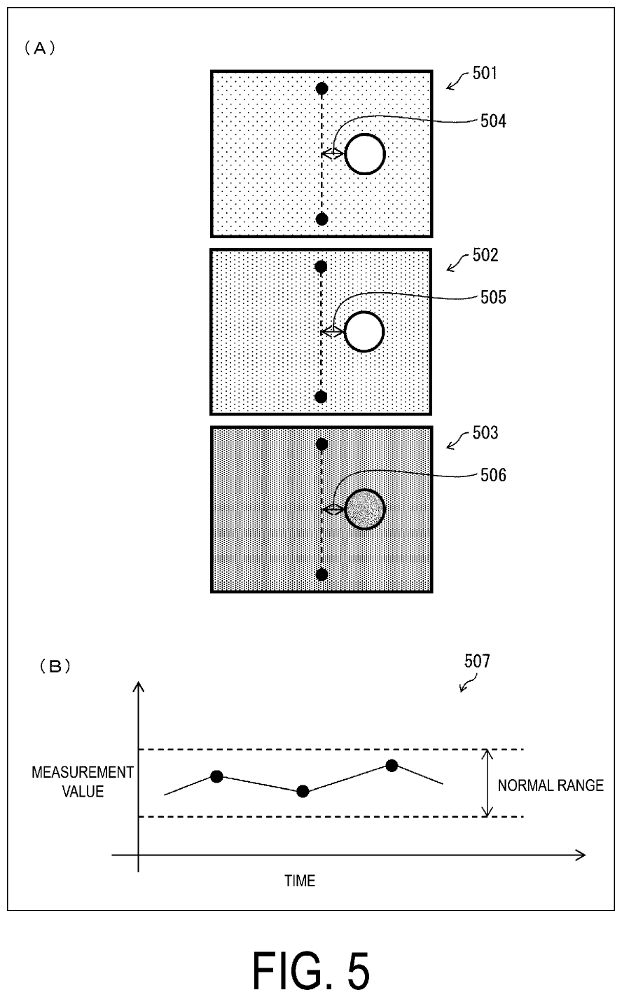

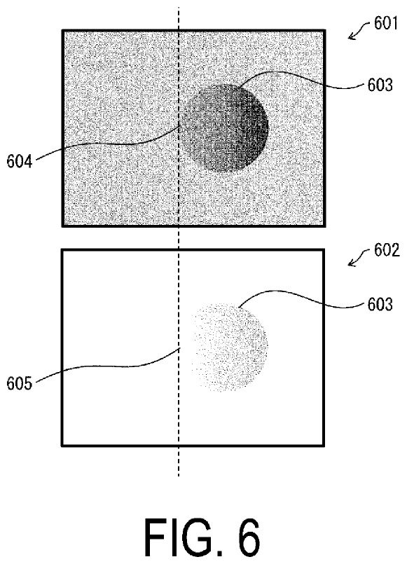

Hereinafter, the storage system 2 according to the second embodiment will be described in detail with reference to FIGS. 5 and 6. Note that, for the sake of description, components having the same functions as the components described in the first embodiment are denoted by the same reference signs, and description thereof will be herein omitted.

Storage System 2

The storage system 2 includes the storage device 20 in place of the storage device 10 according to the first embodiment. Except for this point, the storage system 2 has the same configuration as the storage system 1 according to the first embodiment.

Storage Device 20

The storage device 20 includes a determination unit 202 (not illustrated) and a storage unit 203 (not illustrated) in place of the determination unit 102 and the storage unit 103 in the first embodiment, and further includes an acquisition unit 204 (not illustrated). Except for this point, the storage device 20 has the same configuration as the storage device 10 according to the first embodiment.

Determination Unit 202

The determination unit 202 determines whether to record monitoring information in the storage unit 203 based on, in place of or in addition to a measurement value, an index indicating an environment of a monitoring target at the time of image capturing of the captured image acquired by the acquisition unit 204.

Here, the determination unit 202 determines whether to record the monitoring information in the storage unit 203 based on, in addition to the measurement value, the brightness at the time of image capturing of the captured image acquired by the acquisition unit 204. In this case, when the brightness of the captured image does not fall within a predetermined range, the determination unit 202 determines to record the captured image corresponding to the above brightness in the storage unit 203. More specifically, the determination unit 202 may determine to record, in the storage unit 203, the captured image with the brightness before coming to the outside of the predetermined range and the captured image with the brightness after coming to the outside of the predetermined range caused by image capturing conditions, and may determine to delete the captured image when the brightness falls within the predetermined range without changing the image capturing conditions.

As discussed above, in the case where the index indicating the environment of the monitoring target at the time of taking the captured image does not fall within the predetermined range, by making the determination based on the criterion for considering the monitoring target corresponding to the above index as a recording target, it is possible to suitably make the determination particularly when an abnormal state has actually occurred in the measurement value or a cause of the abnormal state may have occurred although it is difficult to confirm the abnormal state of the measurement value from the measurement value. This makes it possible to reduce the possibility of failing to detect a change in the measurement value due to a measurement error.

Storage Unit 203

In the case where the brightness of a captured image at the time of image capturing does not fall within a predetermined range, the storage unit 203 selectively records the monitoring information based on the criterion for considering the captured image corresponding to the above brightness as the recording target, that is, based on the determination result of the determination unit 202. This makes it possible to suitably record the monitoring target in which a cause of the abnormal state may have occurred while suppressing the data volume of the monitoring information.

By recording a captured image allowed to be recorded by the determination of the determination unit 202 whether to record the captured image based on the captured image, the storage unit 203 can suitably confirm at a later time whether the measurement value is in the abnormal state by referring to the above captured image.

Acquisition Unit 204

The acquisition unit 204 acquires an index indicating an environment of a monitoring target at the time of taking a captured image. Here, the acquisition unit 204 acquires the brightness of a captured image at the time of image capturing via output from a sensor configured to detect the brightness of the captured image. Examples of the acquisition unit 204 include an illuminance sensor.

Selective Recording Example 1 by Storage Unit 203

A selective recording example 1 by the storage unit 203 will be described below by using FIG. 5. FIG. 5 is a diagram illustrating captured images and a graph of a time-passage change in a measurement value. Specifically, (A) of FIG. 5 illustrates captured images 501 to 503 arranged in chronological order. As illustrated in (A) of FIG. 5, two black dots and a white dot larger than two black dots are captured in each of the captured images 501 to 503, where a distance between a dotted line connecting the two black dots and the white point is taken as a monitoring target. In other words, the lengths of arrows 504 to 506 in the captured images 501 to 503, respectively, are monitoring targets. (B) of FIG. 5 is a graph 507 depicting measurement values corresponding to the captured images 501 to 503, and three measurement points indicated in the graph 507 are the measurement values corresponding to the captured images 501, 502, and 503 respectively in order from the left. Note that a normal range meaning that the measurement value is in a normal state is also depicted in the graph 507. As illustrated in the graph 507, all the three measurement values fall within the normal range. Differences among the captured images 501, 502, and 503 will be described below. The arrows (monitoring targets) 504 to 506, which are the same monitoring targets, are image-captured in the captured images 501, 502, and 503, respectively. However, brightness is weakened in the captured image 503 in comparison with the captured images 501 and 502. That is, the brightness of the captured image 503 does not fall within the predetermined range. The causes of different brightness of the captured images include a change of a camera setting and a change of an illumination condition, but the description will be given here considering that the illumination condition has been changed. In particular, in a case of outdoor image capturing, there is a possibility that the illumination condition is significantly changed in such a case that a shield and a cloud that block the illumination are interposed between the illumination (the sun) and a monitoring target. In (A) of FIG. 5, illumination is dark only in the captured image 503 compared to the other two captured images, and in the case where the captured images are taken with the same camera setting, the captured image 503 is captured being darkened. As discussed above, when measuring a measurement value based on a captured image, there is a possibility that the measurement value varies caused by the brightness of the captured image, or the like.

In this case, the determination unit 202 determines whether to record the captured image in the storage unit 203 based on, in addition to the measurement value, the change in brightness, caused by the image capturing condition change, of the captured images 501 to 503 acquired by the acquisition unit 204. The storage unit 203 selectively records the captured image based on a determination result of the determination unit 202. As shown in (B) of FIG. 5, all the measurement values corresponding to the captured images 501 to 503 indicate values within the normal range. However, as shown in (A) of FIG. 2, the captured image's brightness varies significantly between the captured images 502 and 503, and therefore there is a possibility that some image capturing condition has changed during taking the two captured images. Accordingly, the determination unit 202 determines that the captured images 502 and 503 should be recorded in the storage unit 203 based on the change in the captured image's brightness, and then the storage unit 203 records the captured images 502 and 503.

Selective Recording Example 2 by Storage Unit 203

A selective recording example 2 by the storage unit 203 will be described by using FIG. 6. FIG. 6 is a diagram illustrating an example of captured images. Specifically, FIG. 6 is a diagram illustrating captured images 601 and 602, in which an imaging target subject 603 is captured. As illustrated in FIG. 6, the captured image 602 is captured brighter than the captured image 601. When a monitoring target is a leftmost point 604 of the imaging target subject 603, since the contrast between the background and the imaging target subject 603 is high in the captured image 601, the measurement unit 101 can suitably measure the leftmost point 604 of the imaging target subject 603, which is the monitoring target. On the other hand, in the captured image 602, the background and part of the imaging target subject 603 are saturated (blown out highlights), and the boundary between the left side of the imaging target subject 603 and the background is blurred. Due to this, the measurement unit 101 is unable to accurately measure a leftmost point 605 of the imaging target subject 603 in the captured image 602. In other words, in the case where the measurement unit 101 measures the leftmost point 605 of the imaging target subject 603, a measurement error may occur in a measurement value caused by the brightness of the captured image, or the like. As a result, even when there is no change in the leftmost points (monitoring targets) 604 and 605 being the monitoring targets, there is a possibility that the measurement values differ.

Thus, the storage unit 203 selectively records the captured images 601 and 602 in accordance with a determination result of the determination unit 202 based on a change in brightness of the captured image, also in addition to the measurement value.

Selective Recording Effect of Storage Unit 203

As described in the selective recording examples 1 and 2 by the storage unit 203, when a measurement value is calculated based on the captured image, a change in brightness or the like of the captured image may affect the measurement value. Thus, even when a change in the measurement value is actually large, a measurement error may occur due to a change in brightness of the captured image or the like, thereby raising a risk that the change in the measurement value is calculated to be smaller. In contrast, as in the selective recording examples 1 and 2 by the storage unit 203, since the storage unit 203 records the captured images before and after the occurrence of a change in brightness or the like, it is possible to refer to the captured images before and after the occurrence of the change in brightness or the like recorded in the storage unit 203 when it becomes necessary to check the above captured images at a later time.

Note that, in the examples described above, the storage unit 203 selectively records captured images based on a change in brightness of the captured image as an example of an index indicating the environment of the captured image at the time of image capturing, but the present embodiment is not limited thereto. In the present embodiment, in a case where a change in a captured image occurs due to other various causes, the storage unit 203 may selectively record monitoring information based on another criterion by the change in the captured image as the index indicating an environment of the captured image at the time of image capturing. For example, the storage unit 203 may selectively record monitoring information based on a change in shadow accompanying a change in position of illumination (the sun) (a shadow contained in a captured image), or based on a change in noise contained in the captured image accompanying a change in illuminance and a change in camera setting (the degree of a time-passage change in the noise contained in the captured image). In a case where another imaging target subject is captured in a monitoring target region of a certain imaging target subject, the storage unit 203 may selectively record monitoring information based on whether, in the monitoring target region, the another imaging target subject is captured in the monitoring target region of the certain imaging target subject (whether the captured image indicates an entry of an object within the monitoring target). In these cases as well, it is particularly preferable for the storage unit 203 to record the captured image before the change and the captured image after the change. With this, in a case where a change in the captured images causes an abnormal state of the measurement value, these captured images may be taken out from the storage unit 203 at a later time and the cause of the abnormal state of the measurement value may be preferably confirmed.

### Third Embodiment

In the storage device 10 of the storage system 1 according to the first embodiment, in the case where a measurement value does not fall within a predetermined range, the storage unit 103 selectively records monitoring information based on the criterion for considering the monitoring information corresponding to the above measurement value as a recording target. However, as in a storage system 3 (not illustrated) according to a third embodiment, in a case where at least one of temperature and humidity at the time of image capturing of a captured image, and a measurement value corresponding to the above temperature and humidity does not fall within a predetermined range, a storage unit 303 (not illustrated) in a storage device 30 (not illustrated) may selectively record monitoring information based on a criterion for considering the captured image corresponding to at least one of the above temperature and humidity as a recording target.

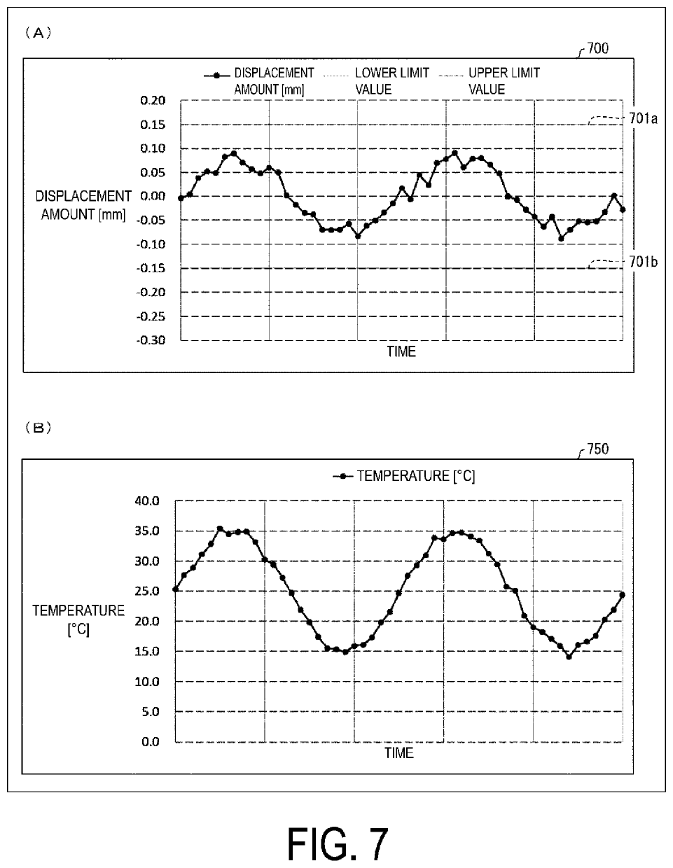

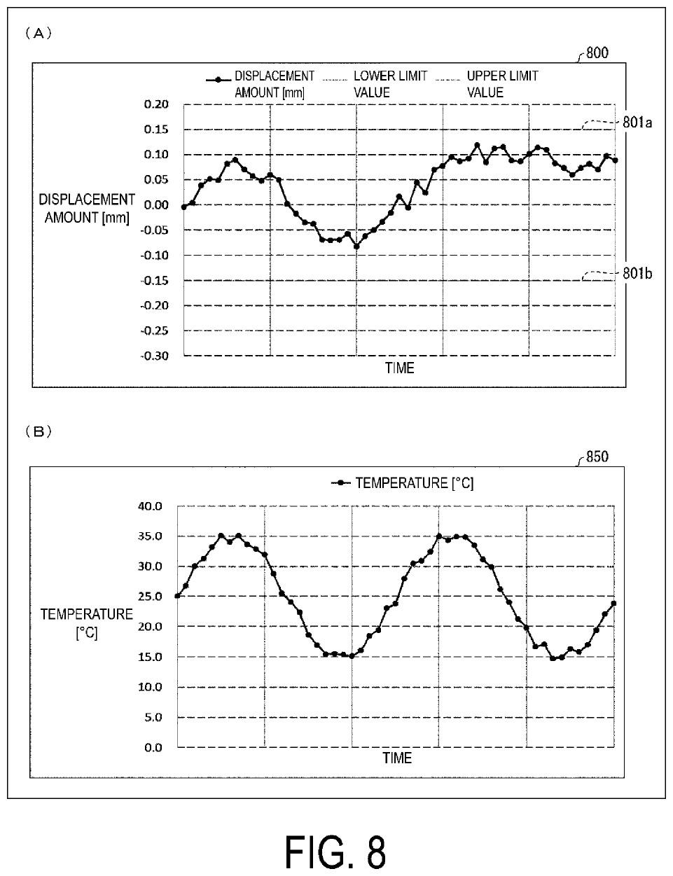

Hereinafter, the storage system 3 according to the third embodiment will be described in detail with reference to FIGS. 7 and 8. Note that, for the sake of description, components having the same functions as the functions of the components described in the embodiments described above are denoted by the same reference signs, and description thereof will be herein omitted.

Storage System 3

The storage system 3 includes the storage device 30 in place of the storage device 10 according to the first embodiment. Except for this point, the storage system 3 has the same configuration as the storage system 1 according to the first embodiment.

Storage Device 30

The storage device 30 includes a determination unit 302 (not illustrated) and a storage unit 303 (not illustrated) in place of the determination unit 102 and the storage unit 103 in the first embodiment, and further includes an acquisition unit 304 (not illustrated). Except for this point, the storage device 30 has the same configuration as the storage device 10 according to the first embodiment.

Determination Unit 302

The determination unit 302 determines whether to record monitoring information in the storage unit 303 based on, in place of or in addition to a measurement value, an index indicating an environment of a monitoring target at the time of image capturing of the captured image acquired by the acquisition unit 304. The determination unit 302 determines whether to record the monitoring information in the storage unit 303 based on, in addition to the measurement value, at least one of the temperature and the humidity at the time of image capturing of the captured image acquired by the acquisition unit 304.

There is a possibility that a change such as shrinkage occurs in a monitoring target due to a change in environment of the monitoring target such as temperature or humidity at the time of taking the captured image, and the measurement value may be affected by the change of the monitoring target. In the case where the monitoring target has changed as described above, the change of the monitoring target is unlikely to appear in the captured image, unlike the case of brightness of the captured image. Because of this, it is difficult to determine whether to perform recording based on the captured image when the monitoring target has changed due to the change in environment of the monitoring target such as temperature or humidity at the time of taking the captured image.

In contrast, the determination unit 302 determines whether to record monitoring information in the storage unit 303 based on at least one of the temperature and the humidity. In this case, when at least one of the temperature and the humidity at the time of taking a captured image, and a measurement value corresponding to the above temperature and humidity does not fall within a predetermined range, the determination unit 302 may determine to record the captured image before the temperature and humidity come to the outside of the predetermined range and the captured image after the change, and determine not to record the captured image where the measurement value corresponding to the temperature and humidity falls within the predetermined range. This makes it possible to reduce, while suppressing the data volume of monitoring information, the possibility of failing to detect abnormality of the measurement value caused by temperature or humidity, which is difficult to recognize from only the captured image and the measurement value.

Storage Unit 303

In the case where a measurement value corresponding to at least one of temperature and humidity at the time of taking a captured image does not fall within a predetermined range, the storage unit 303 selectively records monitoring information based on the criterion for considering the captured image corresponding to the above temperature and humidity as a recording target, that is, based on the determination result of the determination unit 302. This makes it possible to suitably record, while suppressing the data volume of the monitoring information, the monitoring target in which an abnormal state caused by the temperature or humidity, which is difficult to recognize from only the captured image and the measurement value, may have occurred.

Acquisition Unit 304

The acquisition unit 304 acquires an index indicating an environment of a monitoring target at the time of taking a captured image. The acquisition unit 304 acquires at least one of temperature and humidity at the time of taking a captured image. Examples of the acquisition unit 304 include a temperature sensor configured to detect temperature and a humidity sensor configured to detect humidity. In this case, the storage device 30 may display at least one of the temperature information and the humidity information acquired by the acquisition unit 304 on a display device (not illustrated) installed around the storage system 3. The image capturing unit 11 of the storage system 3 takes a captured image with at least one of the temperature information and the humidity information being displayed on the display device, and inputs the captured image to the measurement unit 101 of the storage device 30. With this, the determination unit 302 is able to acquire the temperature information and the humidity information from the captured image inputted to the measurement unit 101, and make the determination.

Selective Recording Example 1 by Storage Unit 303

A selective recording example 1 by the storage unit 303 will be described below by using FIG. 7. FIG. 7 is a graph showing an example of time-passage changes in a measurement value and in temperature. A graph 700 shown in (A) of FIG. 7 is a graph depicting an example of a time-passage change in a measurement value by the measurement unit 101. Specifically, (A) of FIG. 7 is a graph depicting a time-passage change in a displacement amount of a monitoring target. In the graph 700 of (A) of FIG. 7, there is depicted a displacement amount of the monitoring target calculated based on a captured image of the monitoring target. Then, the determination unit 302 determines whether the displacement amount of the monitoring target falls within a predetermined range, thereby determining whether the displacement amount is in a normal state. As shown in (A) of FIG. 7, an upper limit value 701a and a lower limit value 701b of the displacement amount determined to be in the normal state are each indicated by a broken line in the graph 700. Furthermore, as shown in (A) of FIG. 7, the displacement amounts fall within a normal region, which is a region determined to be in the normal state between the upper limit value 701a and the lower limit value 701b, and exhibit a periodic fluctuation close to the form of a sine wave. A graph 750 shown in (B) of FIG. 7 is a graph depicting an example of a time-passage change in temperature around a monitoring target corresponding the displacement amount of the monitoring target depicted in the graph 700. The time corresponding to each of the displacement amounts and the time corresponding to each of the temperatures depicted in the two graphs, that is, the graphs 700 and 750, are all coincident with each other. As shown in the graph 750 of (B) of FIG. 7, similarly to the displacement amounts, the temperatures also exhibit a periodic fluctuation close to the form of a sine wave. Furthermore, as shown in (A) and (B) of FIG. 7, the displacement amount increases as the temperature rises, and the displacement amount decreases as the temperature falls.

Thus, the determination unit 302 may determine, based on (A) and (B) of FIG. 7, that the displacement amount depicted in the graph 700 is a displacement amount displaced following the temperature change, and that the displacement amount linked to the temperature within a range of the normal region as illustrated in the graph 700 is in the normal state, and may determine not to record at least one of the displacement amount determined to be in the normal state and the captured image corresponding to the above displacement amount (monitoring information) in the storage unit 303. In this case as well, when the captured image has not been recorded for a predetermined period of time or longer, the determination unit 302 determines to record the monitoring information in the storage unit 303 regardless of the determination result. This makes it possible for the storage unit 303 to selectively record the monitoring information in such a manner as to suitably suppress the data volume of the monitoring information. Furthermore, it is possible to reduce the possibility of failing to detect abnormality of the displacement amount caused by temperature or humidity, where it is difficult to recognize the change in the displacement amount from the captured image.

Selective Recording Example 2 by Storage Unit 303

A selective recording example 2 by the storage unit 303 will be described below by using FIG. 8. FIG. 8 is a graph showing an example of time-passage changes in a measurement value and in temperature. A graph 800 shown in (A) of FIG. 8 is a graph depicting a time-passage change in a displacement amount of a monitoring target which is the same as the monitoring target from which the displacement amount in the graph 700 is calculated. A graph 850 shown in (B) of FIG. 8 is a graph depicting an example of a time-passage change in temperature around a monitoring target corresponding to the displacement amount of the monitoring target depicted in the graph 800. When comparing FIGS. 7 and 8, as shown in (B) of FIG. 7 and (B) of FIG. 8 respectively, the graph 750 and the graph 850 of the time-passage changes in temperature are the same in that each graph depicts a fluctuation at a prescribed period, that is, at a period close to that of a sine wave. However, as shown in (A) of FIG. 7 and (A) of FIG. 8, the graphs 700 and 800 of the time-passage changes in the displacement amounts depict different displacement amounts from each other at the time of the latter part of measurement. As shown in (A) of FIG. 8, in the graph 800, the displacement amount exhibits a different fluctuation from that of a sine wave at the time of the latter part of measurement. Thus, in FIG. 8, the displacement amount itself falls within a range between an upper limit value 801a and a lower limit value 801b, which is determined to be in a normal state, at the time of the latter part of measurement, but the displacement amount does not periodically fluctuate. Accordingly, displacement different from the displacement linked to a temperature change may have occurred at the time of the latter part of measurement, and an event that causes some abnormal state may have occurred.

The determination unit 302 may determine the necessity of the recording based on the temperature and the humidity in addition to the displacement amount and the time-passage change in the displacement amount. In this case, the determination unit 302 determines whether the displacement amount is in an abnormal state after referring to the temperature and the humidity. Then, the determination unit 302 determines that the captured image corresponding to the displacement amount before being determined to be in the abnormal state and the captured image corresponding to the displacement amount after being determined to be in the abnormal state are captured images to be recorded. In this case, the determination unit 302 sees that, as shown in (B) of FIG. 8, the graph 850 of the time-passage change in temperature depicts a fluctuation at a prescribed period, that is, at a period close to that of a sine wave. On the other hand, since the displacement amount in FIG. 8(A) does not fluctuate periodically at the time of the latter part of measurement, the determination unit 302 determines that the displacement amount in the latter part of measurement in FIG. 8(A) is in the state to be recorded. In a case where the graph 850 of the time-passage change in temperature in (B) of FIG. 8 does not depict a periodic fluctuation at the time of the latter part of measurement, that is, in a case where the temperature in the graph 850 does not fall within a predetermined range at the time of the latter part of measurement, the determination unit 302 determines that the captured image corresponding to the displacement amount at the time of the latter part of measurement should be recorded in the storage unit 303. The storage unit 303 records the captured image based on the determination result of the determination unit 302. In this way, by recording the captured images before and after the occurrence of abnormality in the displacement amount accompanying a change in temperature or humidity that is difficult to recognize from the change in the captured image, the captured images recorded in the storage unit 303 can be referred to in the case where the need for confirmation occurs at a later time.

The determination unit 302 determines whether to record monitoring information in the storage unit 303 based on, in place of or in addition to a measurement value, an index indicating an environment of a monitoring target at the time of image capturing of the captured image acquired by the acquisition unit 304. The determination unit 302 determines whether to record the monitoring information in the storage unit 303 based on, in addition to the measurement value, at least one of the temperature and the humidity at the time of image capturing of the captured image acquired by the acquisition unit 304.

In the example described above, the determination unit 302 determines whether to record the monitoring information in the storage unit 303 based on at least one of the temperature and the humidity at the time of image capturing of the captured image, but the present embodiment is not limited thereto. In the present embodiment, the determination unit 302 may determine whether to record monitoring information in the storage unit 303 based on, in place of or in addition to at least one of the temperature and the humidity, an index indicating another environment of the monitoring target at the time of image capturing of the captured image acquired by the acquisition unit 304. It is sufficient that the index indicating another environment is an index highly likely to exert an influence on a measurement value, and examples thereof may include atmospheric pressure, vibrations, ambient sound, wind velocity, and quantity of rain. Furthermore, the determination unit 302 may receive alarms of an earthquake, a weather and the like, and may use these alarms as indices indicating other environments.

### Fourth Embodiment

In the storage device 10 of the storage system 1 according to the first embodiment, the storage unit 103 does not allow a criterion to be met to differ, that is, does not allow a predetermined period of time to be referred to when recording monitoring information regardless of the determination result to differ between the captured image and the measurement value. However, as in a storage unit 403 (not illustrated) in a storage device 40 (not illustrated) of a storage system 4 (not illustrated) according to a fourth embodiment, criteria to be met, that is, predetermined periods of time referred to when monitoring information is recorded regardless of the determination result may be separately provided to a captured image and a measurement value.

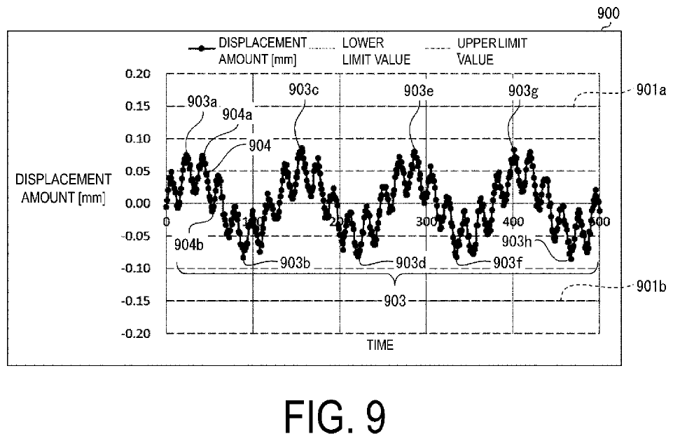

Hereinafter, the storage system 4 according to the fourth embodiment will be described in detail with reference to FIG. 9. Note that, for the sake of description, components having the same functions as the functions of the components described in the embodiments described above are denoted by the same reference signs, and description thereof will be herein omitted.

Storage System 4

The storage system 4 includes the storage device 40 in place of the storage device 10 according to the first embodiment. Except for this point, the storage system 4 has the same configuration as the storage system 1 according to the first embodiment.

Storage Device 40

The storage device 40 includes a determination unit 402 (not illustrated) in place of the determination unit 102 in the first embodiment, and the storage unit (403). Except for this point, the storage device 40 has the same configuration as the storage device 10 according to the first embodiment.

Determination Unit 402

When the storage unit 403 has not recorded a captured image for a predetermined first period of time or longer, the determination unit 402 causes the storage unit 403 to record the captured image regardless of whether the criterion is met or not. Further, when the storage unit 403 has not recorded a measurement value for a predetermined second period of time or longer, the determination unit 402 causes the storage unit 403 to record the measurement value regardless of whether the criterion is met or not.

Storage Unit 403

When the storage unit 403 has not recorded a captured image for the predetermined first period of time or longer, the storage unit 403 records the captured image in a first mode regardless of whether the criterion is met or not, that is, regardless of the determination result of the determination unit 402. Further, when the storage unit 403 has not recorded a measurement value for the predetermined second period of time or longer, the storage unit 403 records the measurement value in a second mode regardless of the determination result of the determination unit 402.

For example, in a case where the second period of time is shorter than the first period of time, the storage unit 403 can record the measurement value in a shorter period of time than that of the captured image. As described above, measurement values are smaller in data volume than captured images, and are generally larger in data volume in a normal state than that in an abnormal state. Because of this, when the storage unit 403 has recorded a measurement value in a short period of time compared to a captured image, it is possible for the storage unit 403 to suitably confirm whether the measurement value is in a normal state while suppressing the data volume. In addition, by recording the measurement values in a shorter period of time than that of the captured images, it is possible to record a measurement value with data volume less than that of the captured image, the measurement value suggesting that an event that causes an abnormal state may have occurred. This makes it possible to suitably refer to the measurement value recorded by the storage unit 403 when it becomes necessary to check the event that causes the abnormal state at a later time.

In a case where the second period of time is longer than the first period of time, the storage unit 403 can record a captured image in a shorter period of time than that of a measurement value. In this case, failure to detect abnormality of a measurement value may be suitably suppressed in the measurement putting a larger emphasis on checking a situation in which the measurement value is in an abnormal state.

In the example described above, the storage unit 403 stores, in the second mode, monitoring information such as measurement values that are not recorded in the first mode, but may not record them. The storage period of the second mode may be shorter than that of the first mode, or the degree of compression of the second mode may be higher than that of the first mode; conversely, the storage period of the first mode may be shorter than that of the second mode, or the degree of compression of the first mode may be higher than that of the second mode.

Selective Recording Example by Storage Unit 403

A selective recording example by the storage unit 403 will be described below by using FIG. 9. FIG. 9 is a graph showing an example of a time-passage change in a measurement value calculated by the measurement unit 101. In a graph 900 of FIG. 9, there is depicted a displacement amount of a monitoring target calculated based on a captured image. Then, the determination unit 402 determines whether the displacement amount of the monitoring target falls within a predetermined range, thereby determining whether the displacement amount is in a normal state. As illustrated in FIG. 9, an upper limit value 901a and a lower limit value 901b of the displacement amount determined to be in the normal state are each indicated by a broken line in the graph 900. Furthermore, as illustrated in FIG. 9, all of the displacement amounts fall within a normal region, which is a region between the upper limit value 901a and the lower limit value 901b of the displacement amounts determined to be in the normal state, and exhibit a periodic fluctuation close to the form of a sine wave. In FIG. 9, the displacement amount fluctuates with a waveform in which a long-period sine wave 903 and a plurality of short-period sine waves including a sine wave 904 overlap one another, where the amplitude of the displacement amount of the long-period sine wave 903 is larger than that of the short-period sine wave 904. From the perspective of relating to whether the displacement amounts are in the normal state or not, it is better to record, in the storage unit 403, displacement amounts (measurement values) 903a to 903h indicating the upper and lower ends of the amplitude of the long-period sine wave 903 having large amplitude of the displacement amounts than to record the displacement amounts indicating the amplitude states and the lower ends of the plurality of short-period sine waves including displacement amounts (measurement values) 904a and 904b indicating the upper and lower ends of the amplitude of the sine wave 904. From this, even in a case where the second period of time is set so that only the displacement amounts 903a to 903h indicating at least the upper and lower ends of the amplitude of the long-period sine wave 903 are recorded in the storage unit 403, and the captured images corresponding to the displacement amounts indicating the plurality of short-period sine waves including the sine wave 904 unlikely related to whether the displacement amount is in the normal state or not, the influence thereof is small when the abnormal state of the displacement amount is checked. However, the displacement amounts indicating the upper and lower ends of the amplitude of the plurality of short-period sine waves including the displacement amounts 904a and 904b indicating the upper and lower ends of the sine wave 904 are not in the abnormal state, but there is a possibility that the above-mentioned displacement amounts are not meaningless data from a different perspective.

Herein, the first period of time related to a captured image having a large data volume as compared to a displacement amount is set to be longer than the second period of time. The storage unit 403 store all the captured images and displacement amounts for a short period of time, and then deletes the captured images and the displacement amounts based on the longest deletion intervals of the captured images and the displacement amounts. For example, the storage unit 403 may be set so that the longest deletion interval is infinite, and may record all the measurement values.

As described above, by causing the second period of time related to the measurement values to be shorter than the first period of time related to the captured images, a meaningful measurement value can be recorded from a viewpoint different from a determination result telling whether the state is normal or abnormal while reducing the data volume recorded in the storage unit 403. For example, the storage unit 403 records the displacement amounts 904a and 904b indicating the upper and lower ends of the short-period sine wave 904 in the graph 900 of FIG. 9, thereby making it possible to confirm that the state is normal, confirm whether an event that causes an abnormal state has occurred, and the like.

Implementation Example by Software

Control blocks of the storage devices 10, 20, 30, and 40 (in particular, the measurement unit 101, the determination unit 102, and the storage units 103, 203, 303, and 403) may be implemented by logic circuits (hardware) formed in integrated circuits (IC chips) and the like, or may be implemented by software.

In the latter case, the storage devices 10, 20, 30, and 40 are each provided with a computer configured to execute instructions of a monitoring information recording program, which is software for implementing each of the functions. The stated computer includes at least one processor (control device), for example, and includes at least one computer-readable recording medium having stored therein the monitoring information recording program. In the above computer, the processor reads out the monitoring information recording program from the recording medium and executes the program, thereby accomplishing an object of the present embodiment. For example, a Central Processing Unit (CPU) may be used as the processor. As the recording medium, a “non-transitory tangible medium” such as a tape, a disk, a card, a semiconductor memory, and a programmable logic circuit may be used in addition to a Read Only Memory (ROM). A Random Access Memory (RAM) on which the monitoring information recording program is loaded, or the like may be further provided. The monitoring information recording program may be supplied to the computer via any transmission medium (a communication network, broadcast wave, or the like) capable of transmitting the monitoring information recording program. One aspect of the present invention may also be implemented in the form of data signals embedded in a carrier wave, where the monitoring information recording program is embodied by electronic transmission.

1. A monitoring information recording apparatus comprising:
a recording processing unit configured to record, in a case that monitoring information including at least one of a captured image of a monitoring target and a measurement value calculated based on the captured image meets a predetermined criterion, the monitoring information in a first mode,
wherein the recording processing unit records, in a case that the monitoring information has not been recorded in the first mode for a predetermined period of time or longer, the monitoring information in the first mode regardless of whether the criterion is met or not, and
wherein the recording processing unit records, in a case that the captured image has not been recorded in the first mode for a predetermined first period of time or longer, the captured image in the first mode regardless of whether the criterion is met or not, and
in a case that the measurement value has not been recorded in the first mode for a predetermined second period of time or longer, the recording processing unit records the measurement value in the first mode regardless of whether the criterion is met or not.

2. The monitoring information recording apparatus according to claim 1,
wherein the recording processing unit records or does not record in a second mode, the monitoring information that is not recorded in the first mode, and
in the second mode, a storage period is shorter than a storage period in the first mode, or a degree of compression is higher than a degree of compression in the first mode.

3. (canceled)

4. The monitoring information recording apparatus according to claim 1,
wherein the criterion includes a criterion for selecting whether to record the monitoring information in the first mode based on a degree of a time-passage change in the measurement value.

5. The monitoring information recording apparatus according to claim 1,
wherein the criterion includes a criterion for selecting whether to record the monitoring information in the first mode based on brightness of the captured image, a degree of a time-passage change in a shadow contained in the captured image or noise contained in the captured image, or whether the captured image indicates an entry of an object in the monitoring target.

6. The monitoring information recording apparatus according to claim 1, further comprising:
an acquisition unit configured to acquire output from a sensor configured to detect an environment of the monitoring target,
wherein the criterion includes a criterion for selecting whether to record the monitoring information in the first mode based on the output from the sensor acquired by the acquisition unit.

7. A monitoring information recording system comprising:
the monitoring information recording apparatus according to claim 1; and
an image capturing unit configured to image-capture the monitoring target,
wherein the image capturing unit image-captures the captured image.

8. A control method for a monitoring information recording apparatus, the control method comprising:
recording, in a case that monitoring information including at least one of a captured image of a monitoring target and a measurement value calculated based on the captured image meets a predetermined criterion, the monitoring information in a first mode by the monitoring information recording apparatus,
wherein in the recording of the monitoring information, in a case that the monitoring information has not been recorded in the first mode for a predetermined period of time or longer, the monitoring information is recorded in the first mode by the monitoring information recording apparatus regardless of whether the criterion is met or not,
in a case that the captured image has not been recorded in the first mode for a predetermined first period of time or longer, the captured is recorded image in the first mode regardless of whether the criterion is met or not, and
in a case that the measurement value has not been recorded in the first mode for a predetermined second period of time or longer, the measurement value is recorded in the first mode regardless of whether the criterion is met or not.

9. (canceled)

10. A non-transitory computer-readable recording medium containing a monitoring information recording program that causes a computer to function as the recording processing unit according to claim 1, when the program is executed by the computer.
